(19) United States
(12) Patent Application Publication
(10) Pub. No.: US 2008/0215417 A1
(43) Pub. Date: Sep. 4, 2008

(54) Mass Comparative Analysis of Advertising

(75) Inventor: Charles Young, Albuquerque, NM (US)

Correspondence Address: PEACOCK MYERS, P.C., 201 THIRD STREET, N.W., SUITE 1340, ALBUQUERQUE, NM, 87102, US

(73) Assignee: Hello-Hello, Inc., Albuquerque, NM (US)

(21) Appl. No.: 12/037,801

(22) Filed: Feb. 26, 2008

Related U.S. Application Data
(60) Provisional application No. 60/903,685, filed on Feb. 26, 2007.

(51) Int. Cl. G06Q 30/00

(52) U.S. Cl. 705/10

(57) ABSTRACT

Method for rapidly providing analysis data on currently running advertisements. The user can determine which aspects of its or a competitor's recent advertisements are successful, and use that information for purposes such as creating future advertisements.

### CROSS-REFERENCE TO RELATED APPLICATIONS

This application claims the benefit of the filing of U.S. Provisional Patent Application Ser. No. 60/903,685, entitled “Mass Comparative Analysis of Advertising”, filed on Feb. 26, 2007, and the specification thereof is incorporated herein by reference.

### COPYRIGHTED MATERIAL

© 2006 Hello-Hello, Inc. A portion of the disclosure of this patent document contains material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The present invention relates to comparative analysis of advertising, particularly an automated method of providing access and analysis of currently running advertisements.

2. Background Art

Note that the following discussion refers to a number of publications by author(s) and year of publication, and that due to recent publication dates certain publications are not to be considered as prior art vis-a-vis the present invention. Discussion of such publications herein is given for more complete background and is not to be construed as an admission that such publications are prior art for patentability determination purposes.

Companies typically spend about ten percent of the total cost of an advertisement on its development and then ninety percent on the airing of the advertisement. Heretofore, there has been no useful means of quickly determining how well or poorly an advertisement is doing so that an advertisement can be pulled before its full run or else extended for a longer period or increased in its occurrence. This is particularly a problem in the fast food industry, which in the United States produces about fifty new advertisements per month, with little to no pre-testing of advertisements. The packaged food industries suffer similarly. In addition, there is currently no way of examining still-running advertisements in order to create competing or subsequent advertisements.

### BRIEF SUMMARY OF THE INVENTION

The present invention is a method for analyzing and comparing advertisements, the method comprising the steps of obtaining a plurality of advertisements which are currently being displayed; selecting portions of each advertisement; automatically generating a survey comprising the portions of a particular advertisement and questions regarding the portions and the advertisement; electronically sending the survey to a plurality of viewers; automatically analyzing responses from the viewers; correlating appropriate responses with each portion; creating a database of scores for each advertisement and each portion; ranking the advertisements via a plurality of first criteria; ranking the portions according a plurality of second criteria; and displaying the advertisements and portions and rankings thereof on a plurality of internet web pages. The portions are preferably selected from the group consisting of video frames, portions of a print advertisement, and phrases. The analyzing step preferably comprises generating one or more graphs selected from the group consisting of Flow of Attention, Flow of Meaning, and Flow of Emotion. The method preferably further comprises the step of providing one or more reasons used to derive each ranking. The method is preferably completed in less than about two weeks from a release date of an advertisement. The method is more preferably completed in less than about forty-eight hours from the release date. The database is optionally limited by one or more criteria selected from the group consisting of advertisement date, advertiser, sample definition, ranking criteria, and brand values.

The advertisements are preferably sortable according to any of the first criteria. The portions are preferably sortable according to any of the second criteria. The criteria are preferably customized for each industry area. The first criteria are optionally the same as the second criteria. The displaying step preferably comprises displaying criteria for more than one advertisement on a single web page. The displaying step preferably comprises displaying criteria for more than one portion of a particular advertisement on a single web page. The displaying step preferably comprises displaying criteria for one portion each of a plurality of advertisements on a single web page.

The present invention is also a method of creating an advertising campaign comprising analyzing advertisements using the above method, optionally further comprising the step of analyzing highly ranked portions of the advertisements.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a screen shot of the top level of a data display browser application according to the present invention;

FIG. 2 is a screen shot of a comparative display concerning sets of advertisements currently being run by restaurant chains, ranking the sets by an average index score;

FIG. 3 is a screen shot of a comparative display concerning advertisements currently being run by restaurant chains, ranking the advertisements by an index score;

FIG. 4 is a screen shot of a detail view concerning a particular advertisement;

FIG. 5 is a screen shot of a detail view concerning a particular advertisement broken down by a plurality of frames within the advertisement;

FIG. 6 is a screen shot of a detail view concerning a particular frame of a particular advertisement;

FIG. 7 is a screen shot providing to a new user descriptions of the types of information provided by the present invention;

FIG. 8 is a screen shot detailing to a new user the types of information searches that can be conducted with the present invention;

FIG. 9 shows a ranking of a list of phrases for a particular advertisement;

FIG. 10 shows the evaluation of a particular phrase in an advertisement; and

FIGS. 11-30 show an example of a diagnostic report.

### DETAILED DESCRIPTION OF THE INVENTION

The present invention relates to a method of performing analyses of a plurality of current items of advertising being run by competitors, whether in print (including catalogs), audio (such as for radio), or video format, such as for television, film, or the web (including banner advertising) and providing results of the analyses in comparative form to one or more users. Although the examples set forth herein show fast food restaurant services, the present invention is applicable to any types of advertising, including, but not limited to, sit-down restaurants, automobiles, insurance, clothing, travel services, and all products and services that advertise competitively.

Once an advertisement is released, preferably within 24 hours, the present invention comprises obtaining the advertisement. In the case of video advertisements, representative frames are preferably chosen in accordance with techniques disclosed in one or more of commonly-owned U.S. Pat. No. 6,322,368, entitled “Training and Testing Human Judgment of Advertising Materials,” U.S. Pat. No. 7,169,113, entitled “Portrayal of Human Information Visualization,” U.S. Pat. No. 7,151,540, entitled “Audience Attention and Response Evaluation,” or U.S. patent application Ser. No. 11/923,474, entitled “Method for Creating and Analyzing Advertisements,” which are incorporated herein by reference. The frames are preferably stored in a database. In the case of print advertisements, the advertisements are preferably processed and analyzed in accordance with techniques disclosed in one or more of the aforesaid references.

The selected frames are then preferably loaded into an online survey, and respondents are invited, preferably via third party panels, to take the surveys. Preferably at least 75 respondents respond to each item of advertising, and results communicated back to the entity collecting the information in the same fashion. The survey results for each frame, line of copy, and each advertisement as a whole are then preferably automatically tabulated and correlated with the appropriate image. The present invention also preferably creates rankings from the ad level scores, which are then loaded into a database, a report creation tool, and spreadsheet, and the results (spreadsheets and reports, including Flow of Attention®, Flow of Emotion®, Copy Recall and Copy Relevance graphs which are preferably automatically generated) are quickly made available to subscribers or other users, also preferably via the Internet and web browser software or in an electronic form such as a CD or in an automated paper report format. Depending on the number of subjects initially contacted and invited to participate, the analysis could take anywhere from approximately two weeks to less than 24 hours (for a very large initial sample).

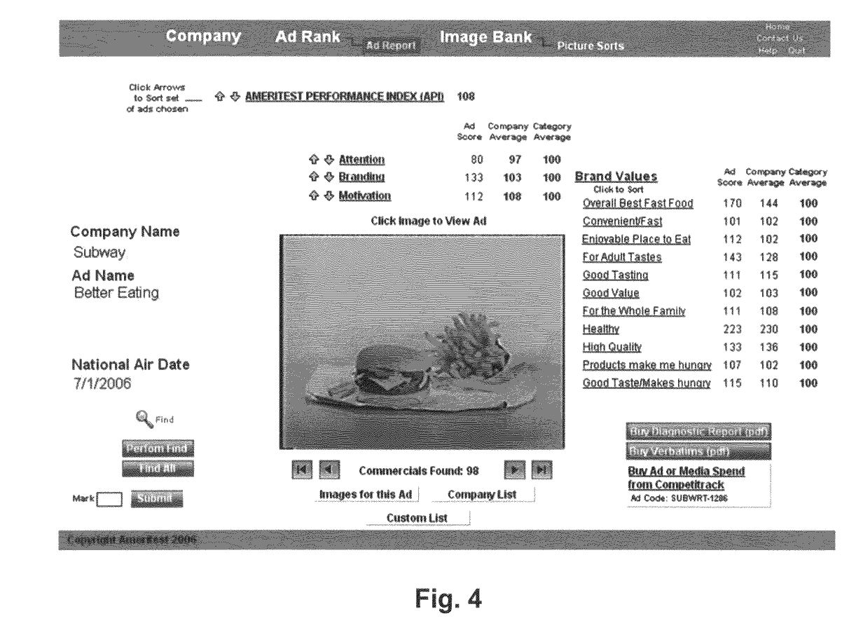

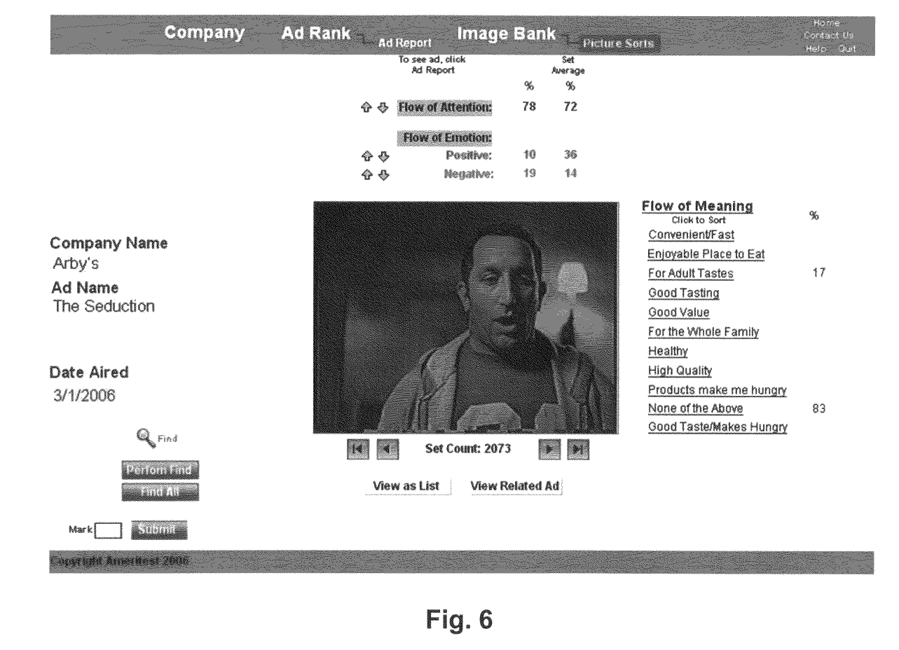

Thus the present invention provides current or “real time” rankings of competitive creative quality or strength on dimensions of advertising performance, including but not limited to attention, branding, motivation, and communication of rational and emotional brand values. Simultaneously in the testing, verbal and non-verbal diagnostic information is preferably collected to analyze and explain the reasons for the advertisings' performance characteristics using quantitative diagnostics. The user can determine why certain advertisements have the score that they do. This is preferably accomplished by allowing the user not only to view the analysis of the advertisement as a whole, but also allowing the user to see the analysis of individual frames, or phrases used in the copy, used in each advertisement (in the case of video advertisements). Performance and Diagnostic measurements of the advertising are vertically integrated or linked by empirically-derived heuristic advertising models so that it is clear to the end user which diagnostics explain which dimension of commercial performance. For example, FIGS. 4 and 6 show linked levels of information, with FIG. 4 showing ad performance as a whole and FIG. 6 showing picture sort level data providing diagnostic insights. FIG. 4 shows that the commercial communicates the idea that Subway sells healthy products; clicking through the frame level data (an example of which for another advertisement is shown in FIG. 6) allows the end user to determine where the idea of healthy is being cued in the ad.

As an example, users may be one or more restaurant chains specializing in quick service, or so-called “fast food” restaurants. At any point in time, each of such chains may have one or more advertisements being run on national television. At the present time, the chains have no way in which to scientifically judge how well their advertising stacks up against that of their competitors, especially currently running or appearing advertising, with respect to any of a number of possible statistics. Accordingly, advertising campaigns are often left to run their course despite later being determined to have been quite ineffective vis-à-vis the competition. Thus an advertiser can, by analyzing its own advertisement in comparison to its competitors' advertisements, use the present invention to determine the length of time, frequency, markets, etc. for which the advertisement should run.

The method of the invention fills this void by, preferably for each and every television advertisement being run by the industry, quickly providing each advertisement to a plurality of test subjects who rank the advertisements in a number of ways, such as described in the references cited above. The results are quickly compiled and added to a database of information (preferably stored in an application such as FileMaker Pro) concerning advertisements currently being run (and/or historically having been run). Within a matter of a day, in many cases, a new ad can be objectively compared against those of the competition, thus providing valuable competitive intelligence to the user. Thus uniquely the present invention provides a searchable database of current rankings of creative quality, based on multiple dimensions of performance, versus “live” competitors in addition to a historical database of older advertising performance.

Because the database of the present invention is preferably continually updated with new advertisements, the database changes with time. So the user can choose to examine advertisements which are currently airing or otherwise appearing, or can select a desired time window (for example, all advertisements shown in the prior three months, or all advertisements airing during a certain time period).

The present invention can also be used as a dynamic learning tool, or visual and verbal dictionary, produced from picture sorts and copy sorts collected across multiple ads in the category, that show how well different brand values have been expressed by different competitors in the category. Attention getting power, emotional impact, and the clarity of the meaning of each image or line of copy are available in a highly searchable format for competitive analysis and learning. This “dictionary” is derived from consumer data, not expert opinion. This tool can be used as a teaching tool for creating improved advertisements and advertising campaigns. A new campaign may be created by looking at campaigns of other advertisers, or older campaigns of the same advertiser.

A custom analysis and resulting database and website may be created for a customer. This analysis could limit the dates of analyzed advertisements, limit the included advertisers, limit the sample definition (for example, target respondents who are women, or who have previously bought a certain brand of automobile), and vary the types and number of brand ratings (e.g. descriptors used in flow of meaning analyses) according to customer requirements.

### EXAMPLE

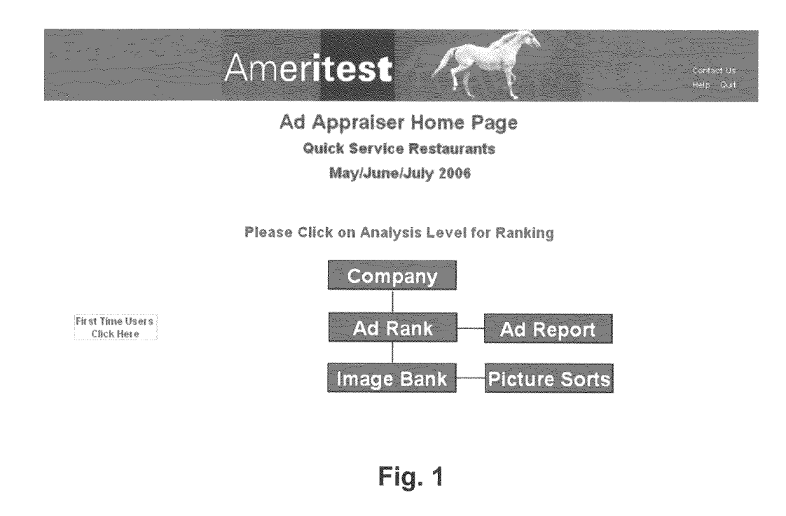

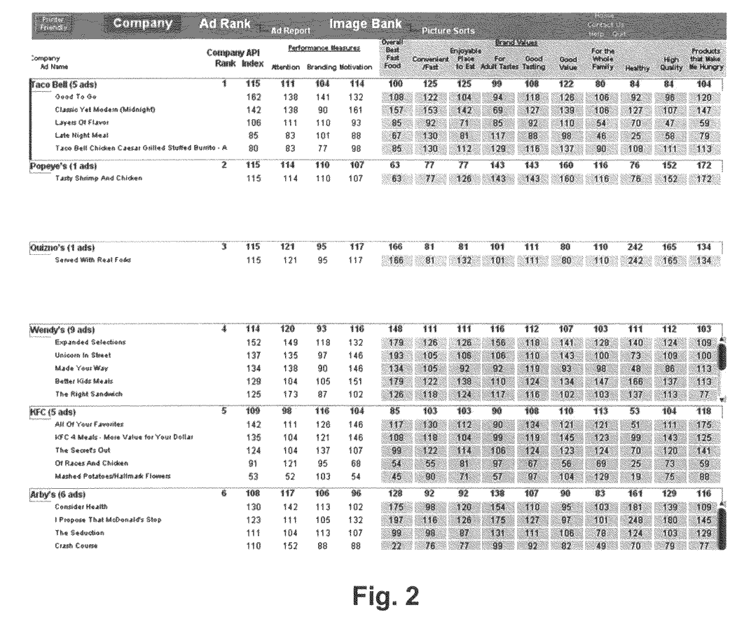

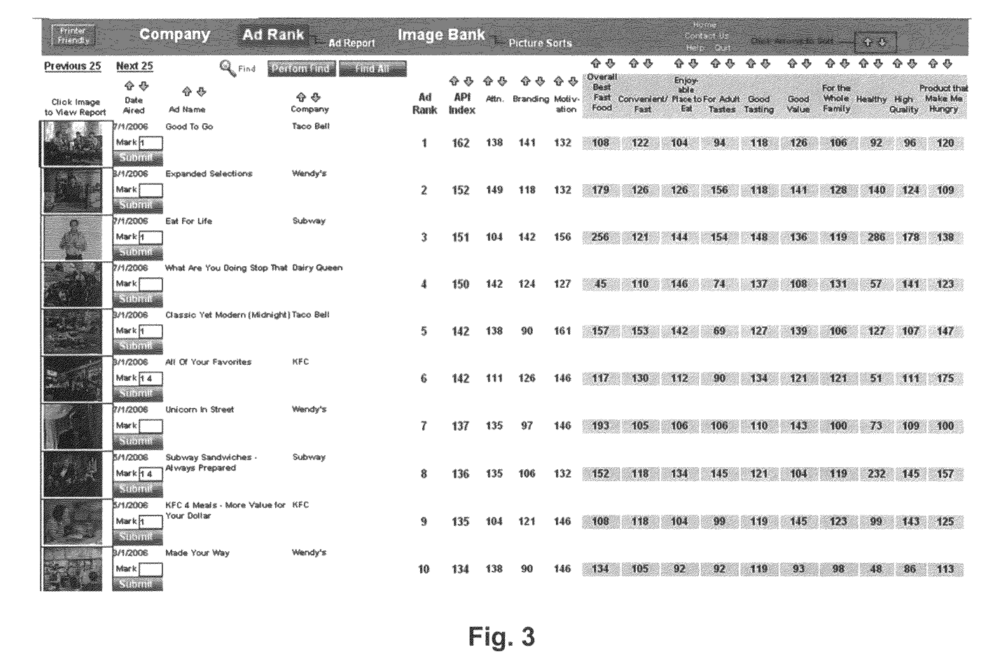

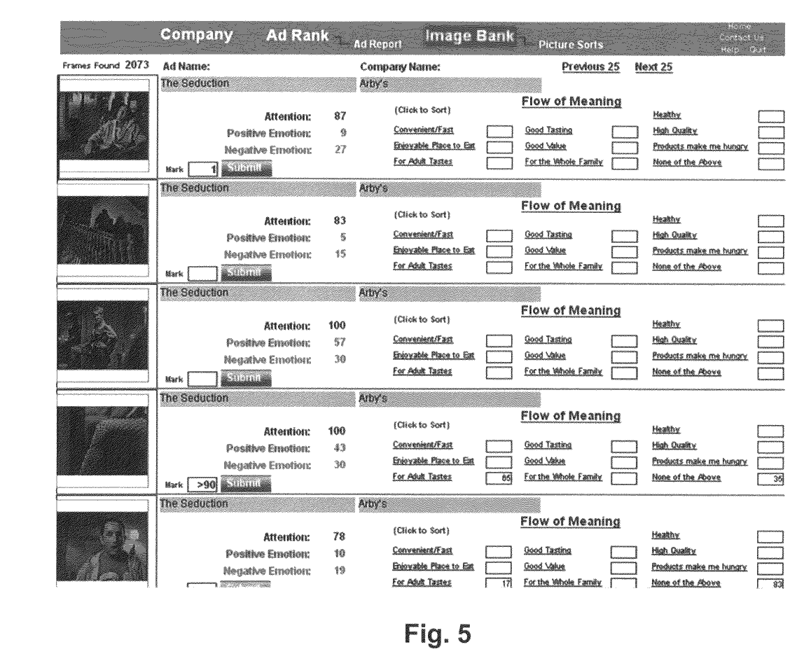

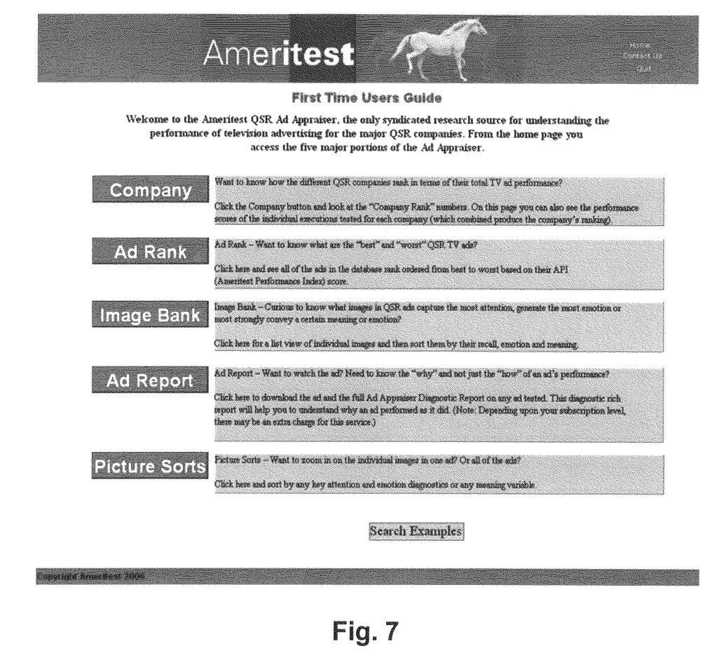

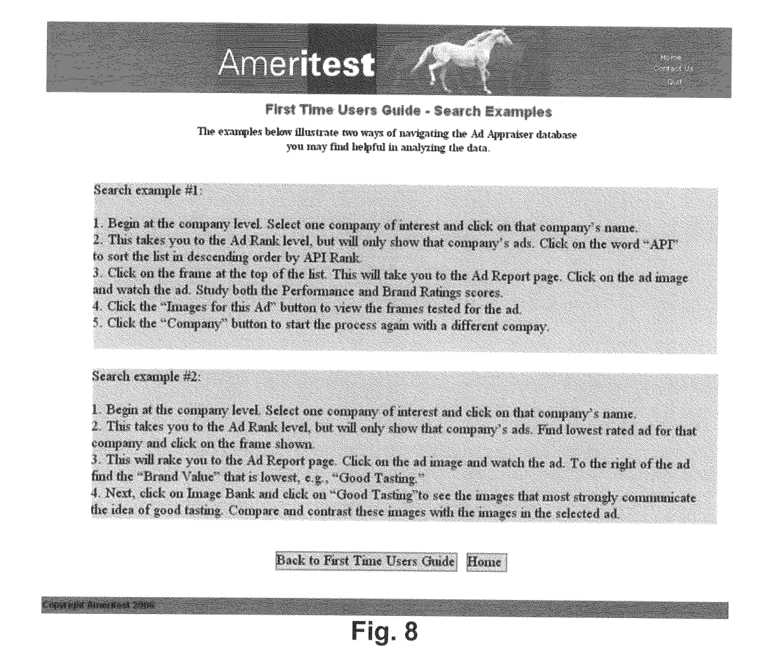

FIG. 1 is a screen shot of the top level of a data display browser application according to the present invention. By clicking on an appropriate analysis level, a user can view data concerning current television advertisements organized by company running the advertisements (FIG. 2) or by the advertisements themselves (FIG. 3). One can also get a report on a particular advertisement (FIG. 4), or review images stored and rated for a particular advertisement (FIG. 5). Additionally, one can sort the images of a particular advertisement (or all or a subset of advertisements) by a number of categories (FIG. 6). New users can get help as to how to start, as well (FIGS. 7 and 8).

FIG. 2 is a screen shot of a comparative display concerning sets of advertisements currently being run by restaurant chains, ranking the sets by an average index score for each advertiser. Companies are also ranked by an average index score as shown. Such score in this case is the Ameritest Performance Index (API) index, a weighted score combining the performance measures of Attention, Branding and Motivation, indexed to the average of weighted scores for in-category ads tested in the past three months. Additionally, performance measures are shown for the advertisements, preferably scores for attention, branding, and motivation. Brand values can also be tabulated and shown, such as “overall best fast food”, “convenient/fast”, “enjoyable place to eat”, “for adult tastes”, “good tasting”, “good value”, “for the whole family”, “healthy”, “high quality”, and “products that make me hungry”. Such brand values are typically different depending on the market being analyzed. By clicking on a column, companies could also be ranked as to average scores for that column. The performance measures are tailored to the specific product or service and are not limited to those described above.

FIG. 3 is a screen shot of a comparative display concerning advertisements currently being run by restaurant chains, ranking the advertisements by an index score. Additionally, performance measures are shown for the advertisements, again preferably scores for attention, branding, and motivation. Brand values can also be tabulated and shown, such as “overall best fast food”, “convenient/fast”, “enjoyable place to eat”, “for adult tastes”, “good tasting”, “good value”, “for the whole family”, “healthy”, “high quality”, and “products that make me hungry”. Advertisements may be sorted in any way. For example, by clicking on a column, advertisements can also be ranked as to average scores for that column. The brand values are tailored to the specific product or service and are not limited to those described above.

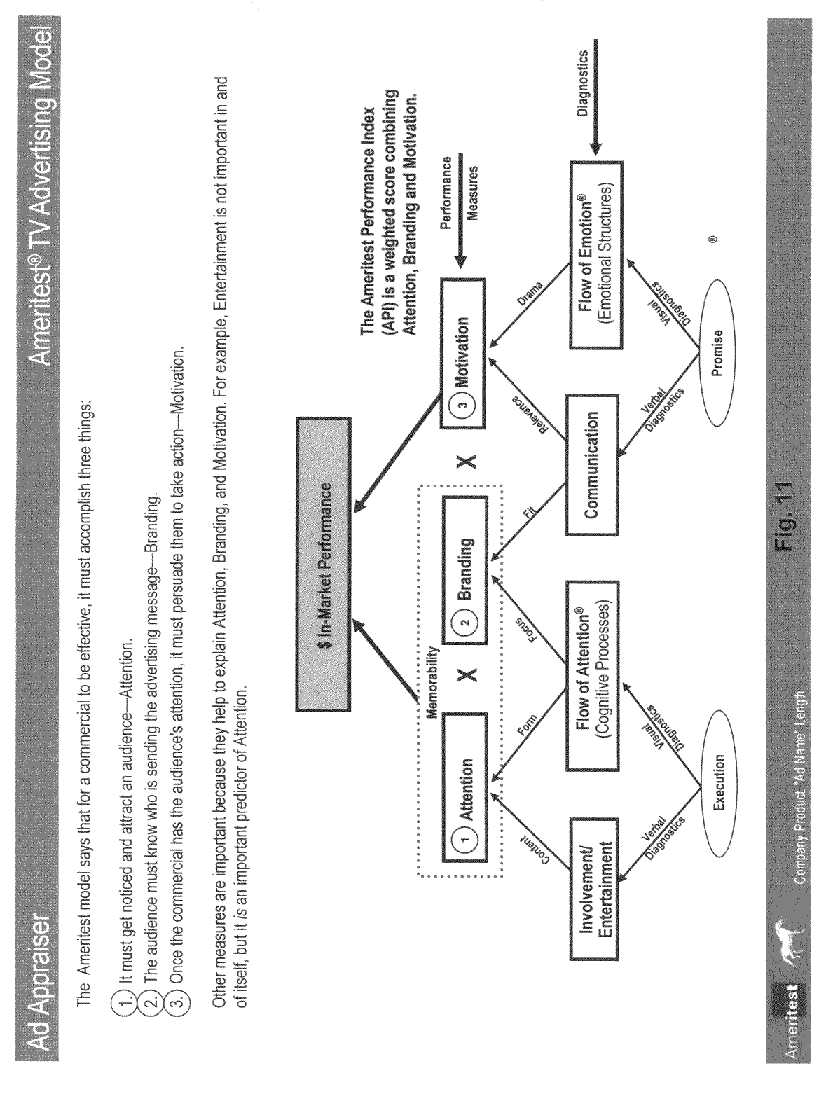

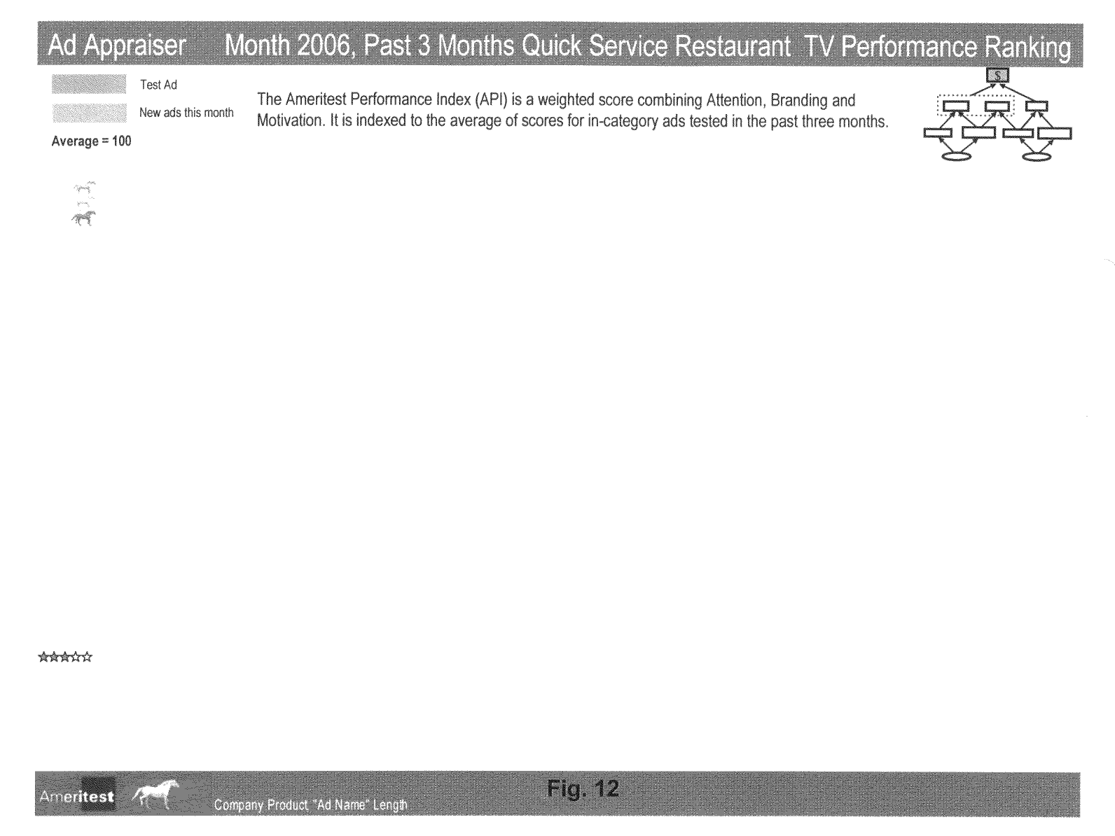

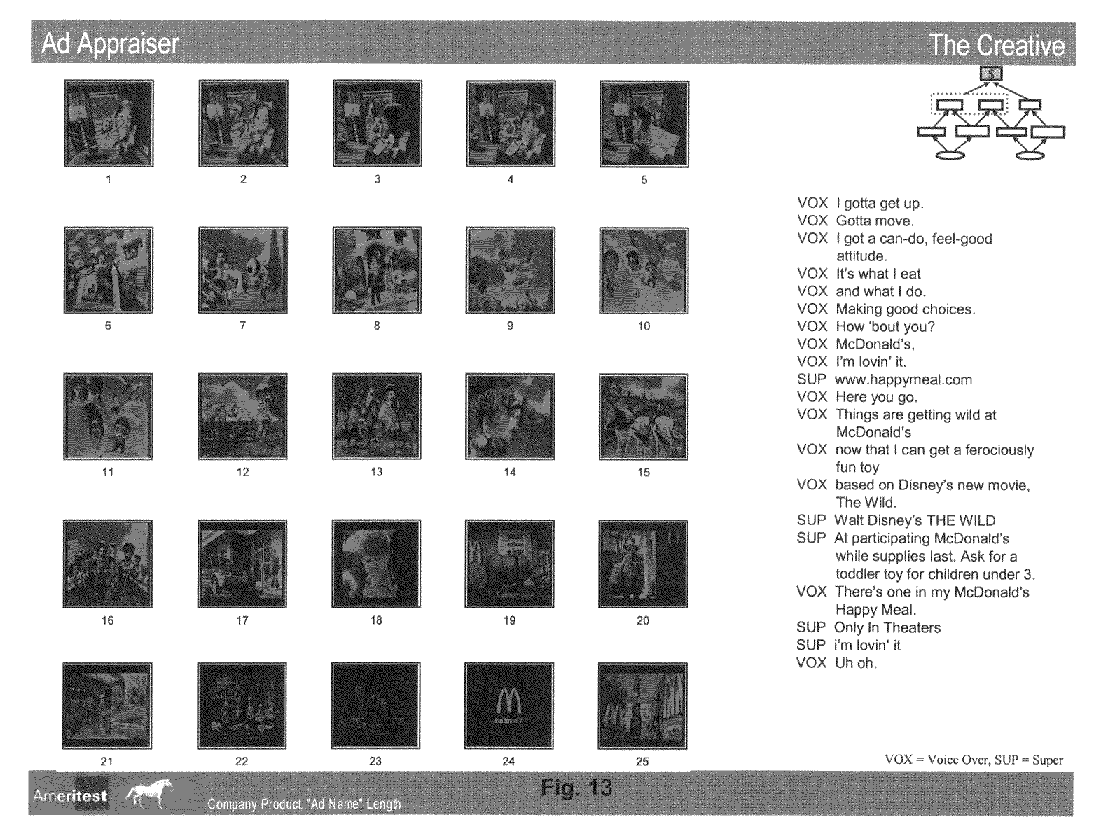

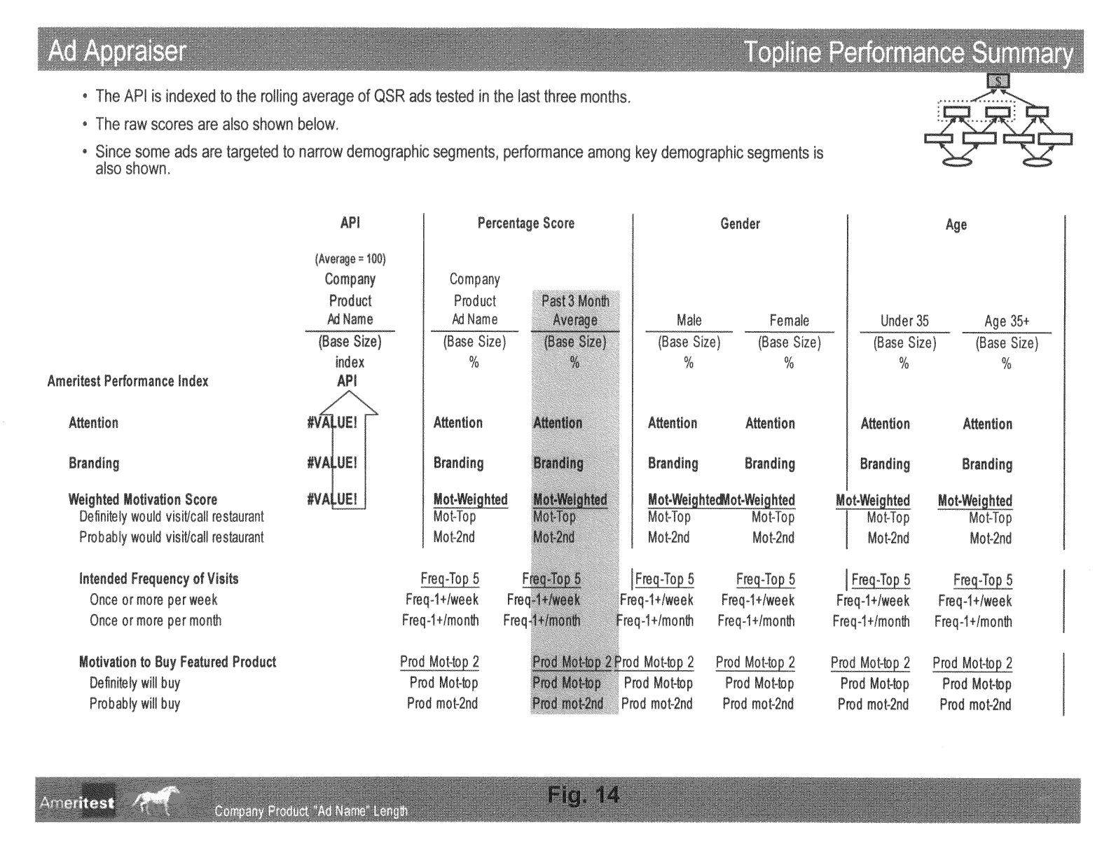

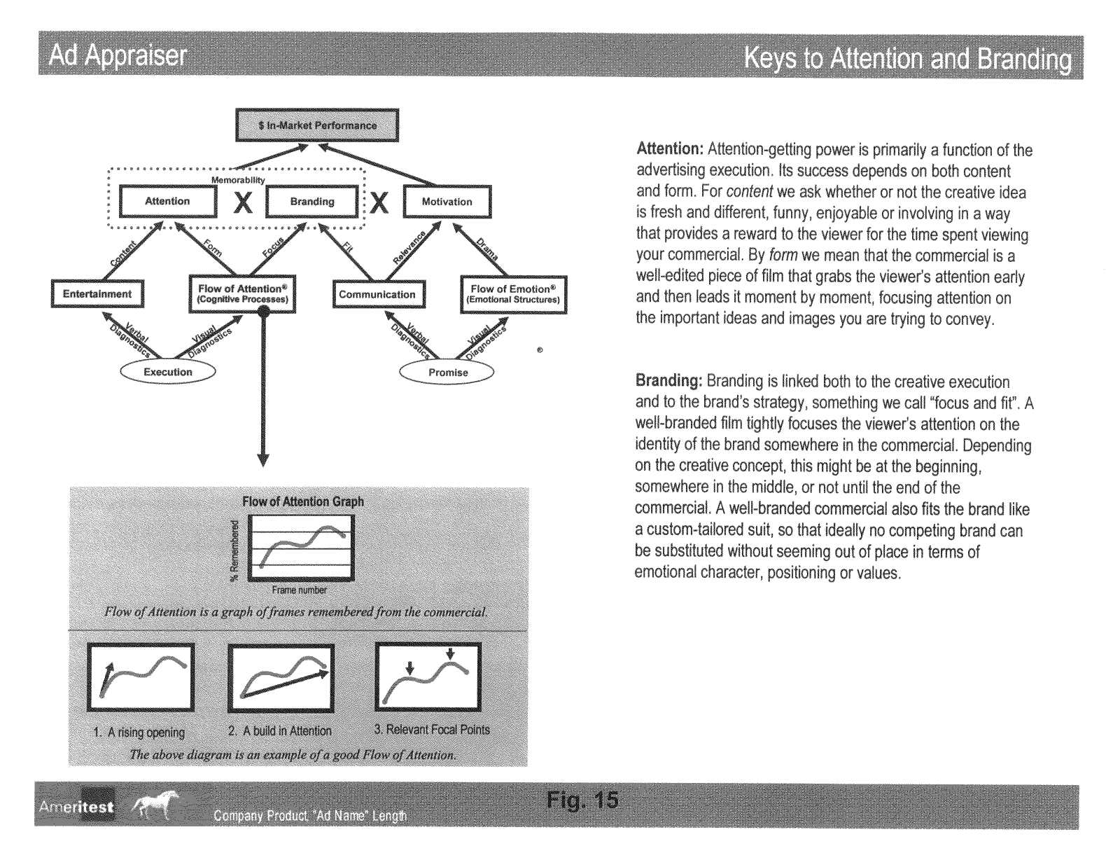

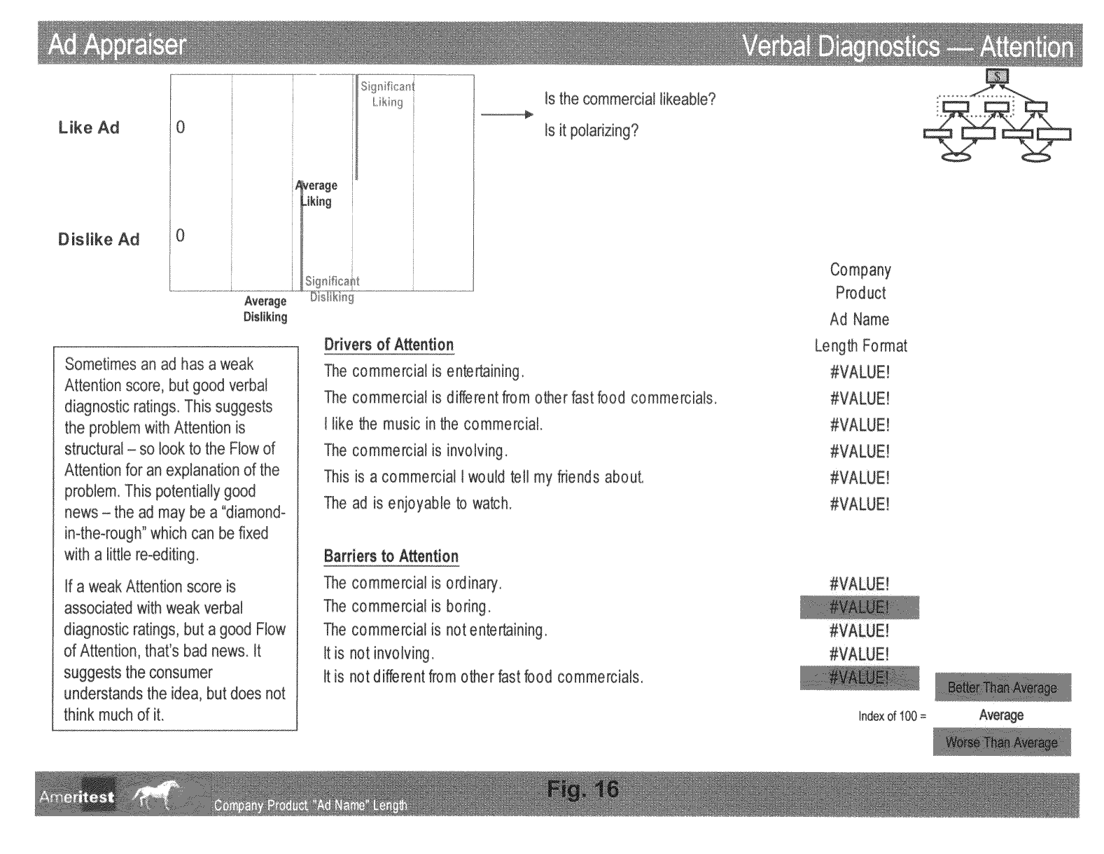

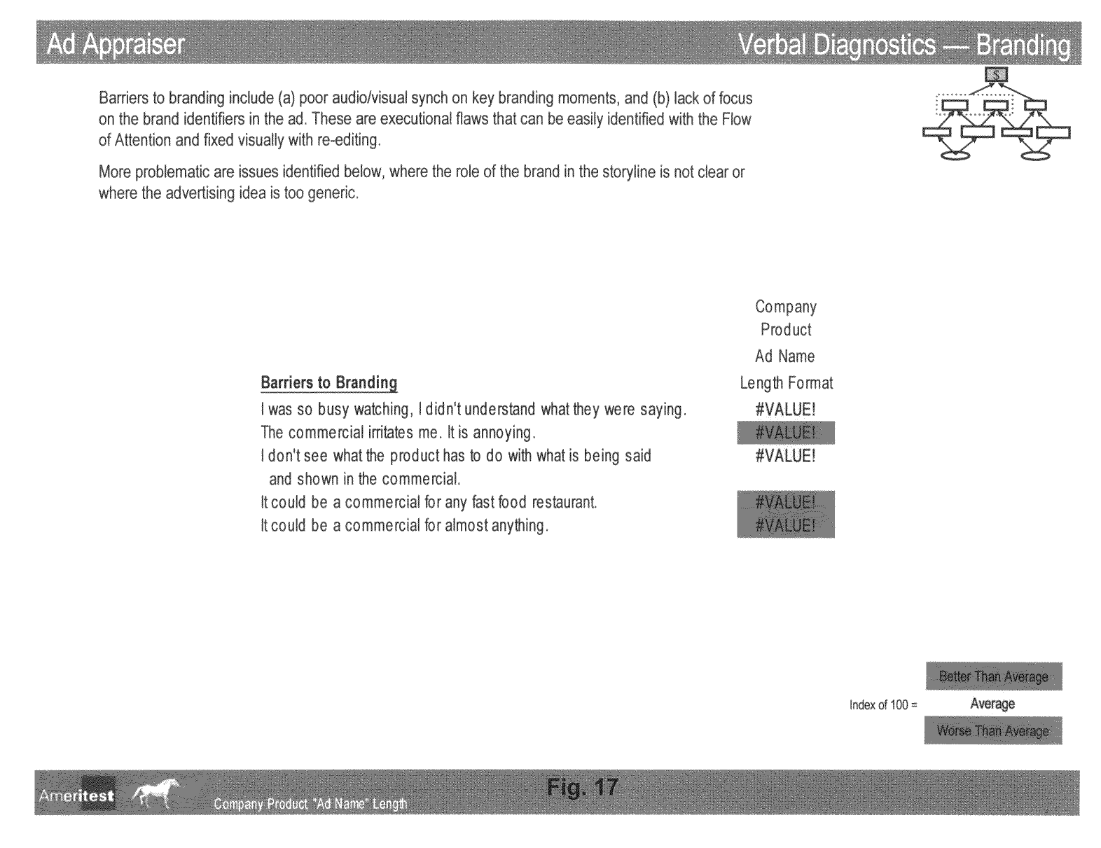

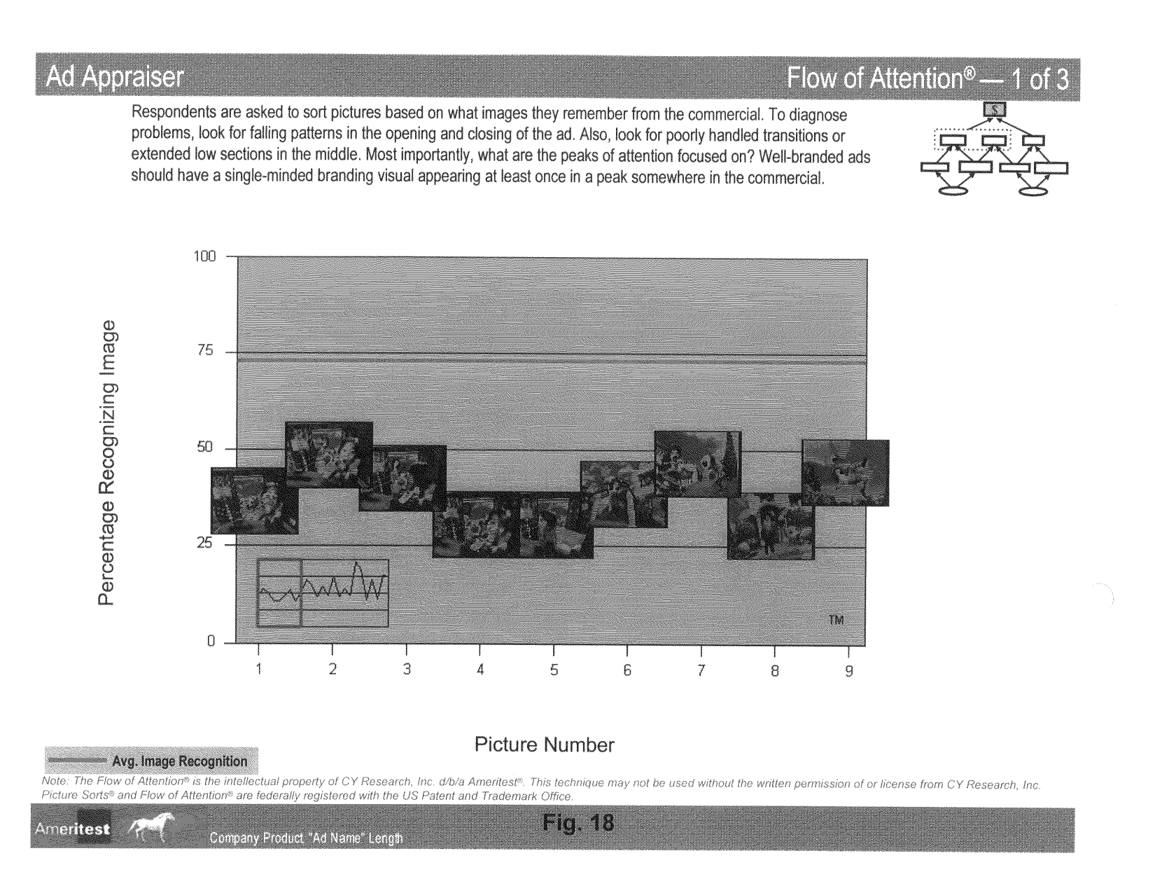

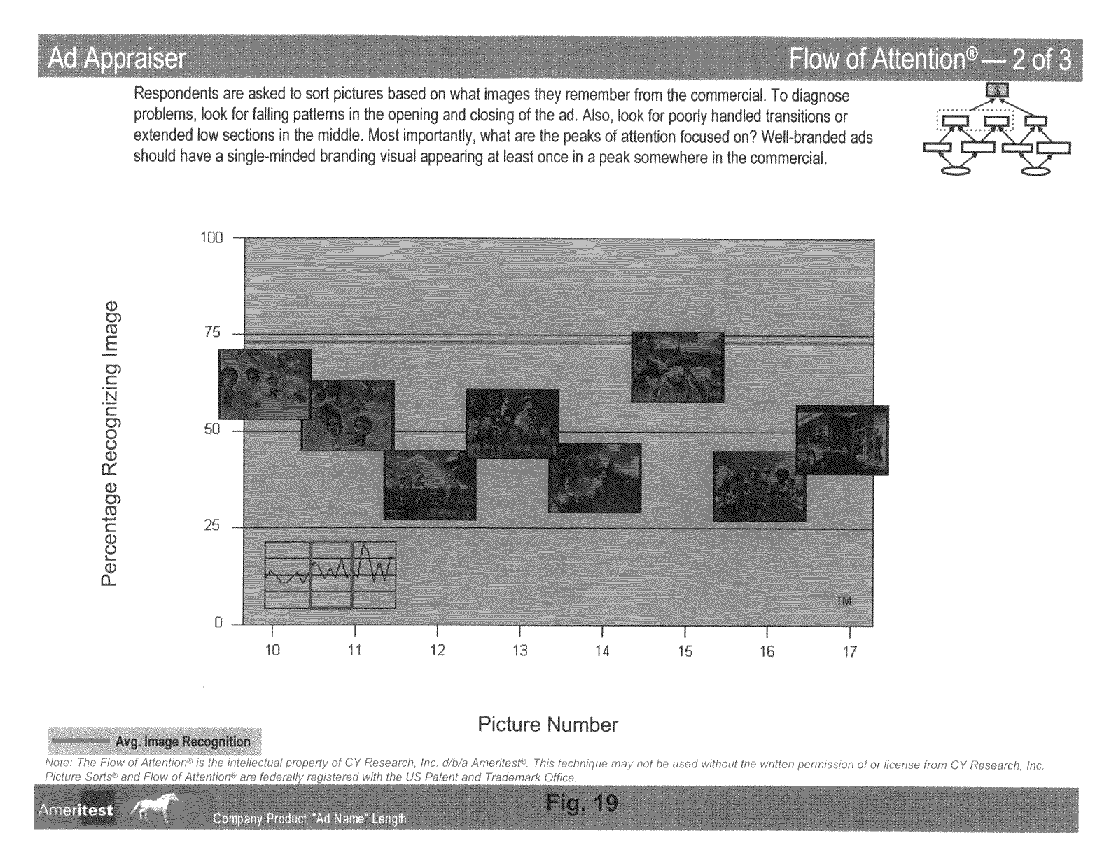

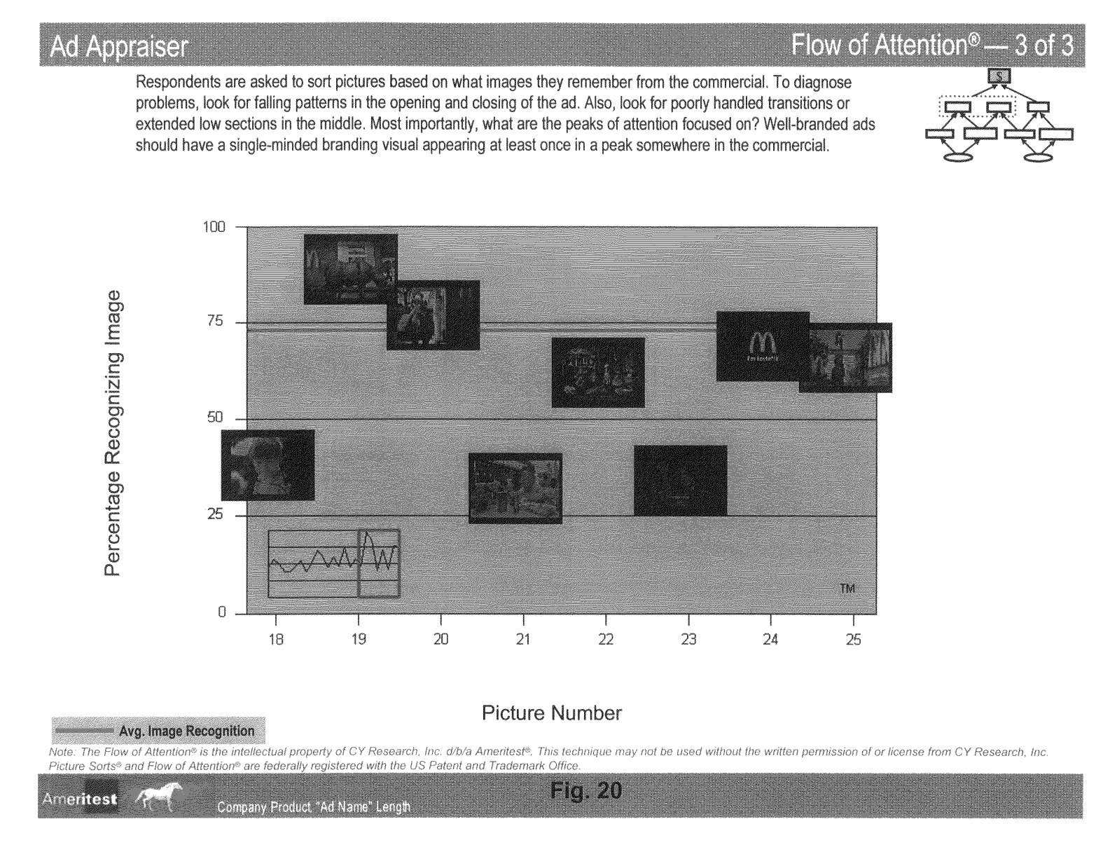

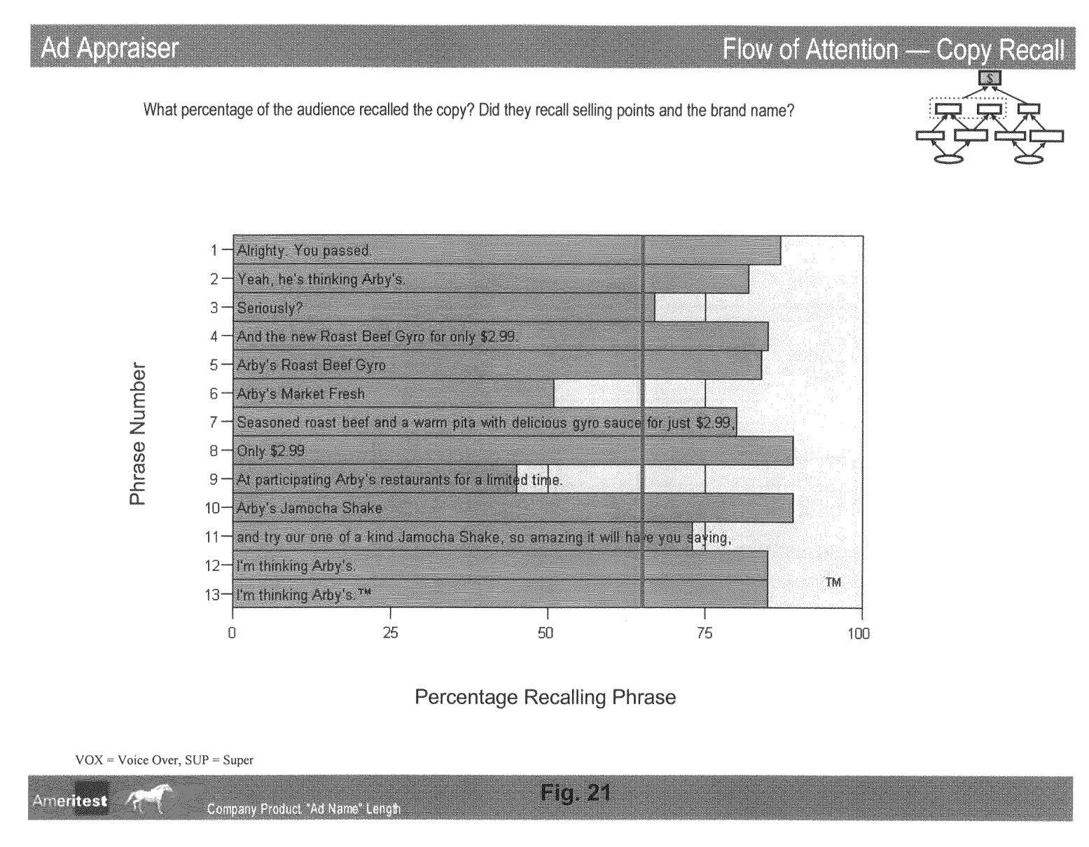

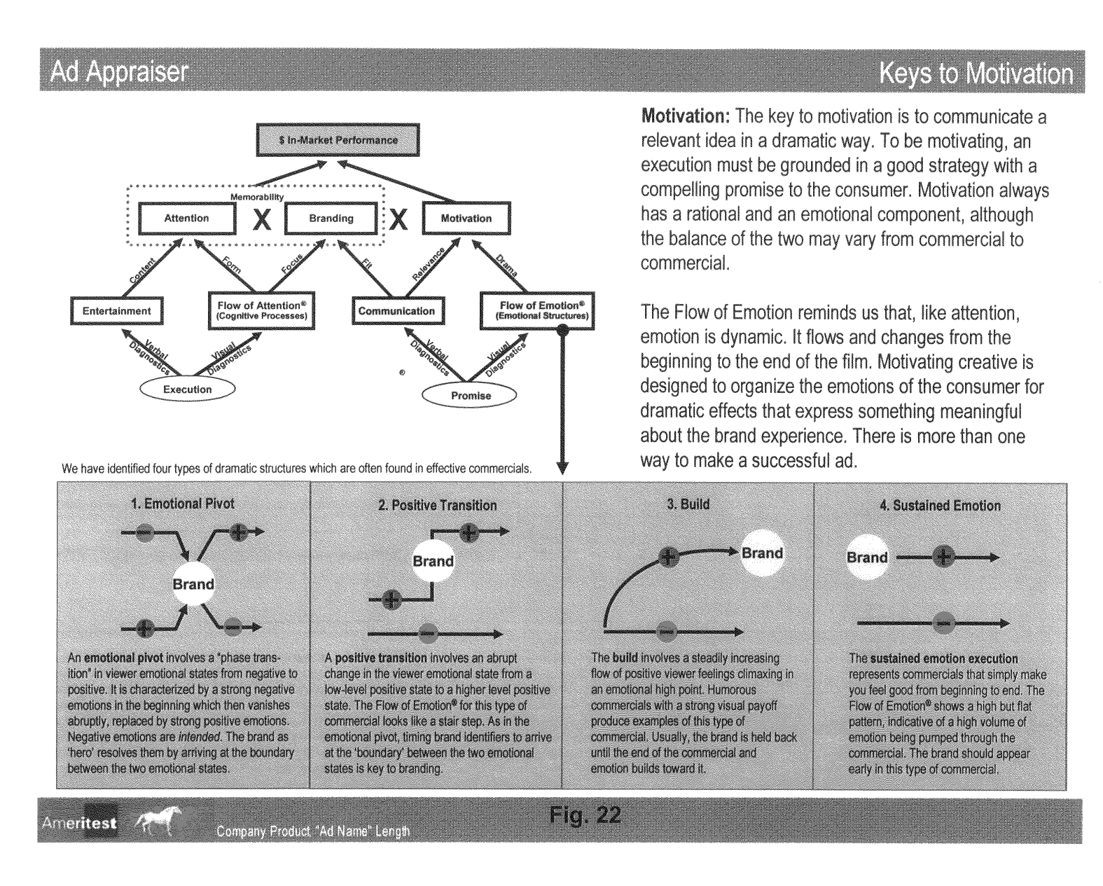

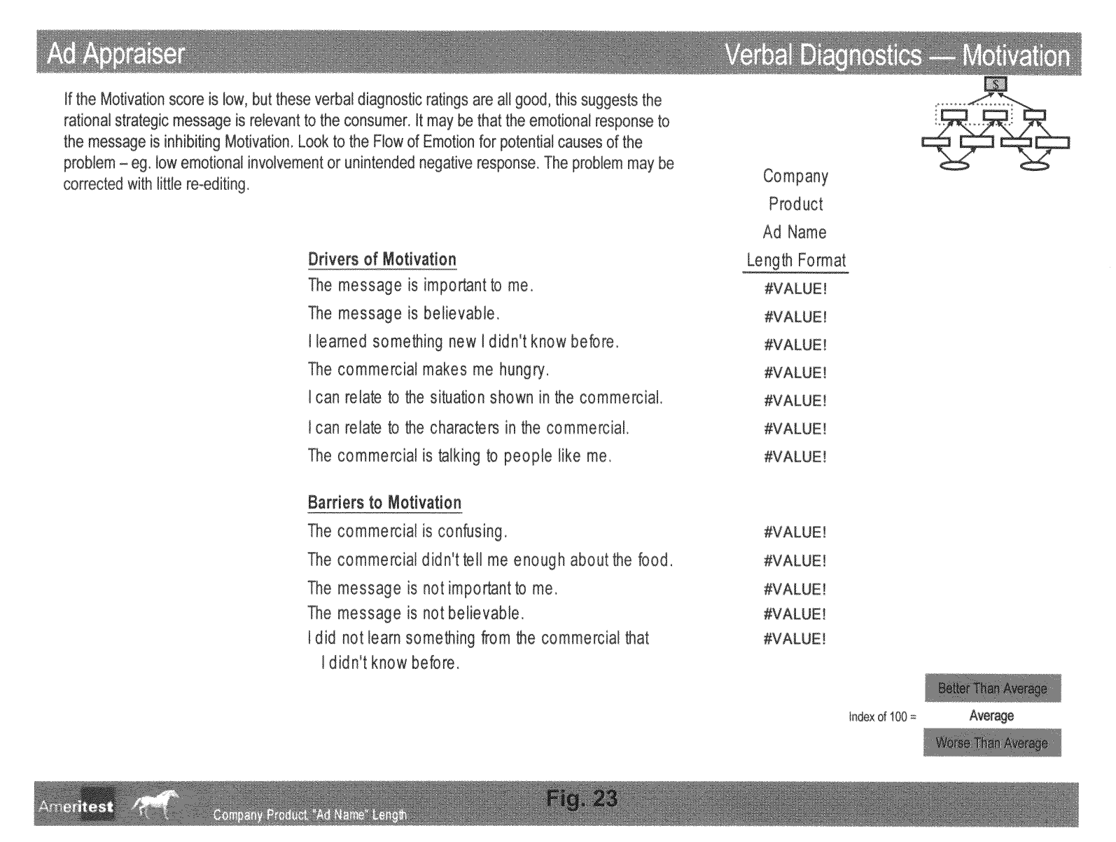

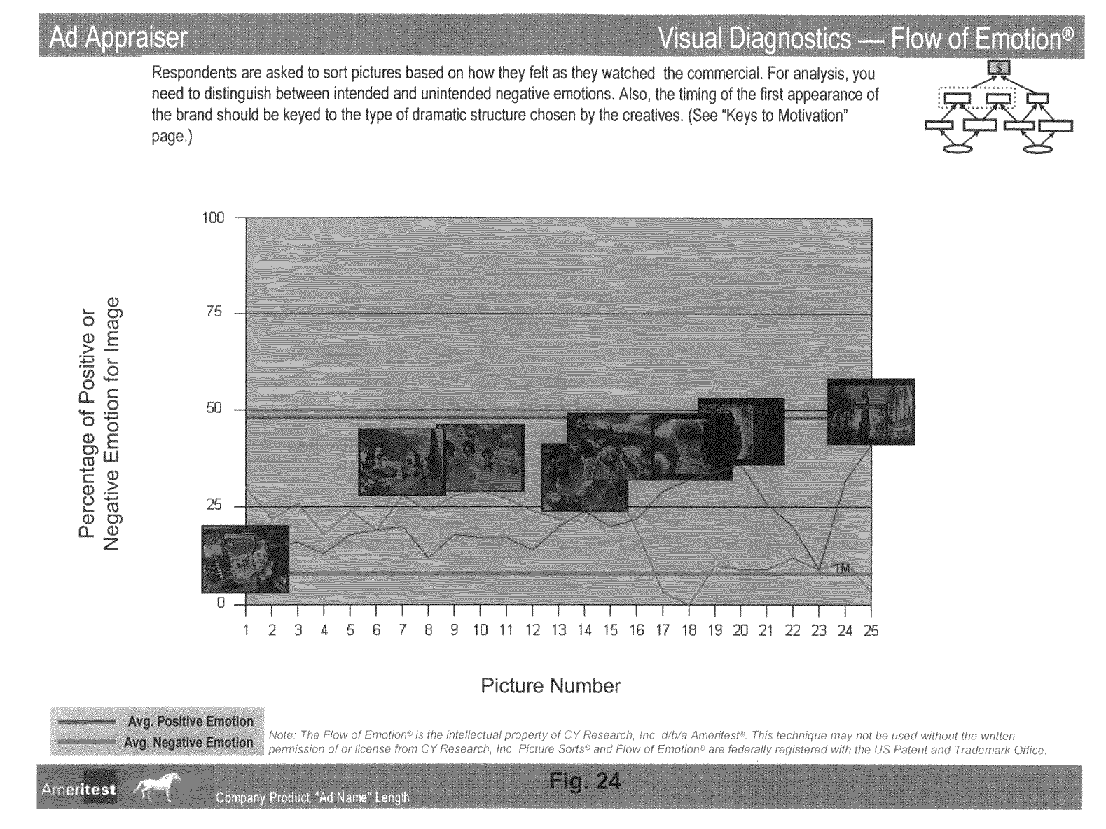

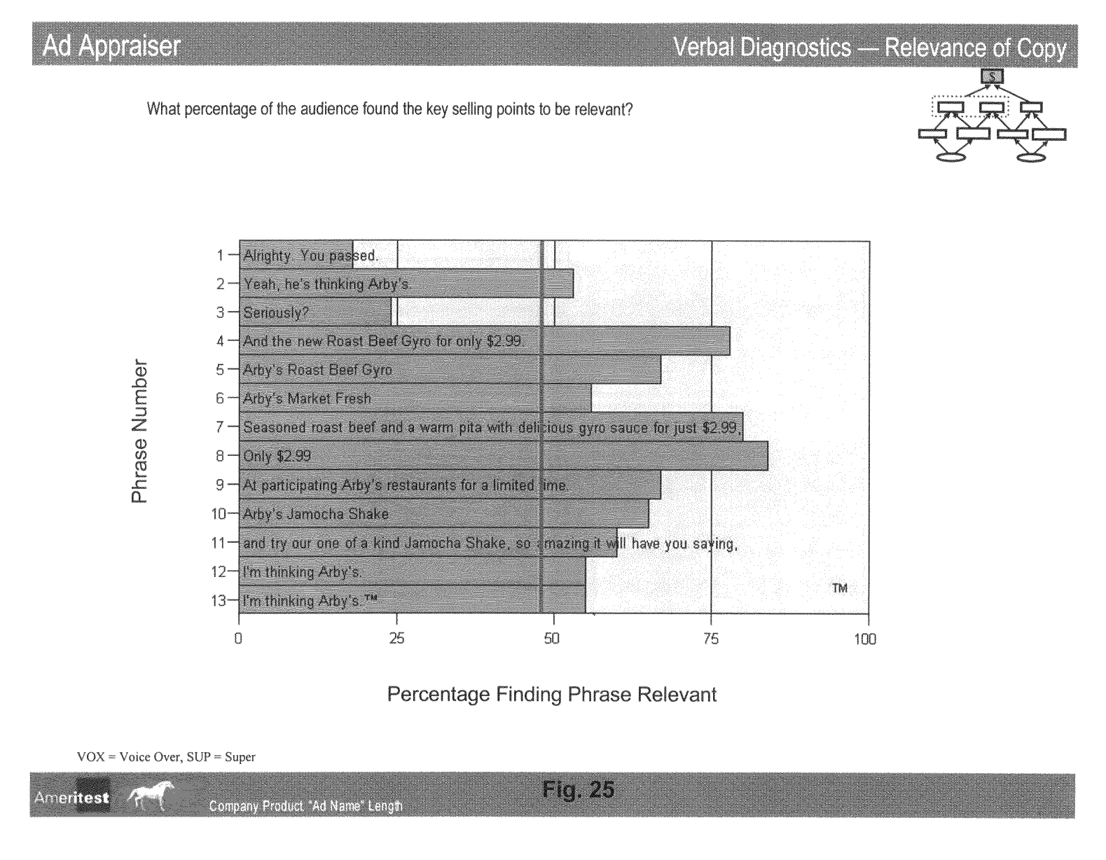

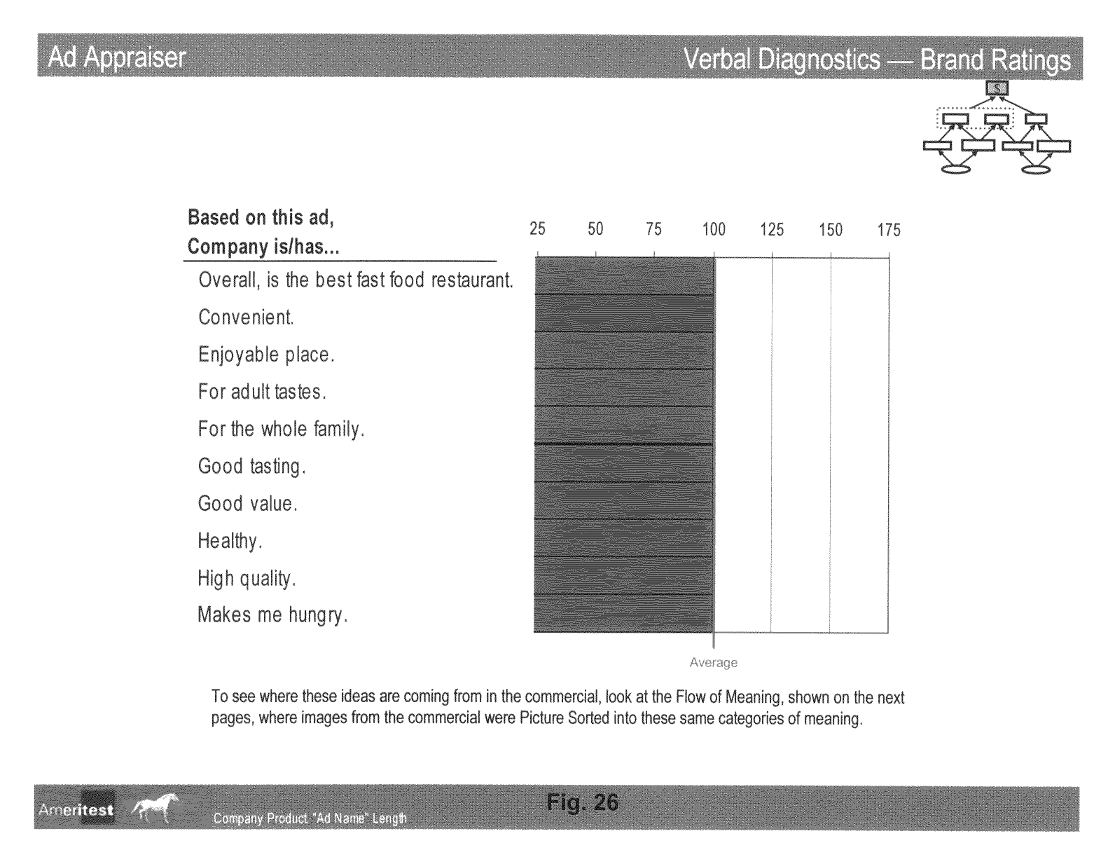

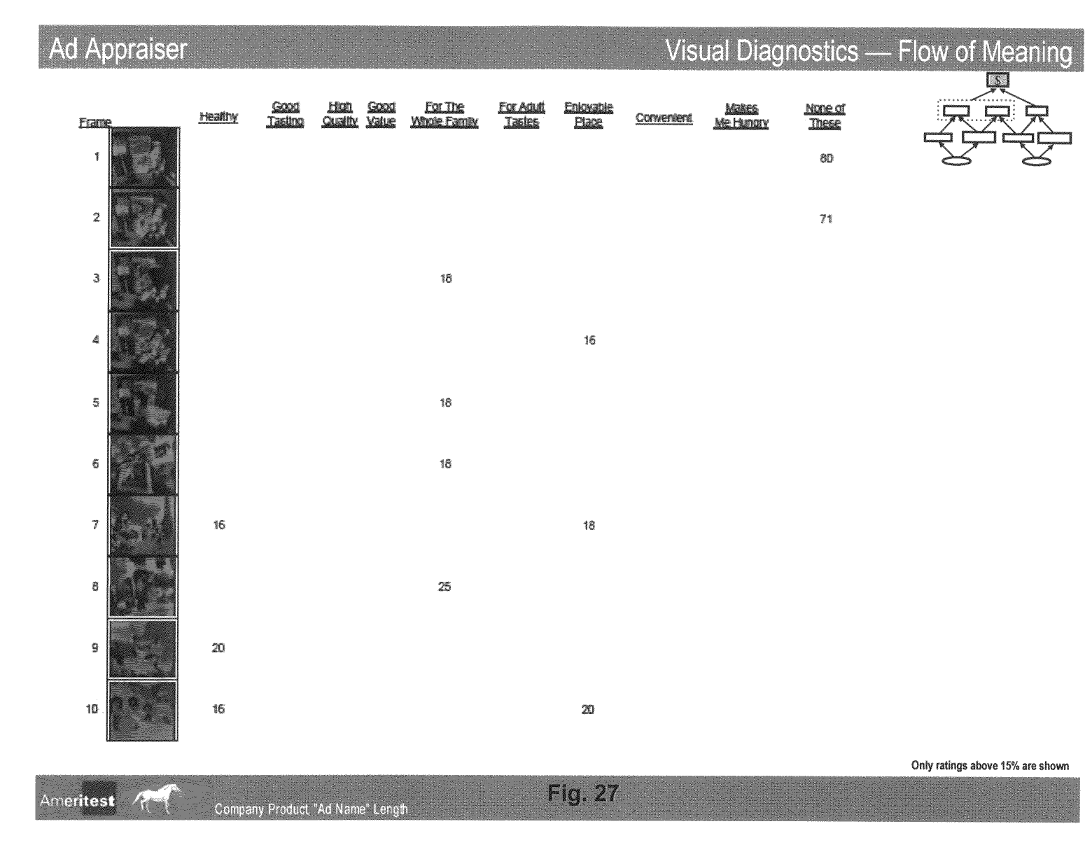

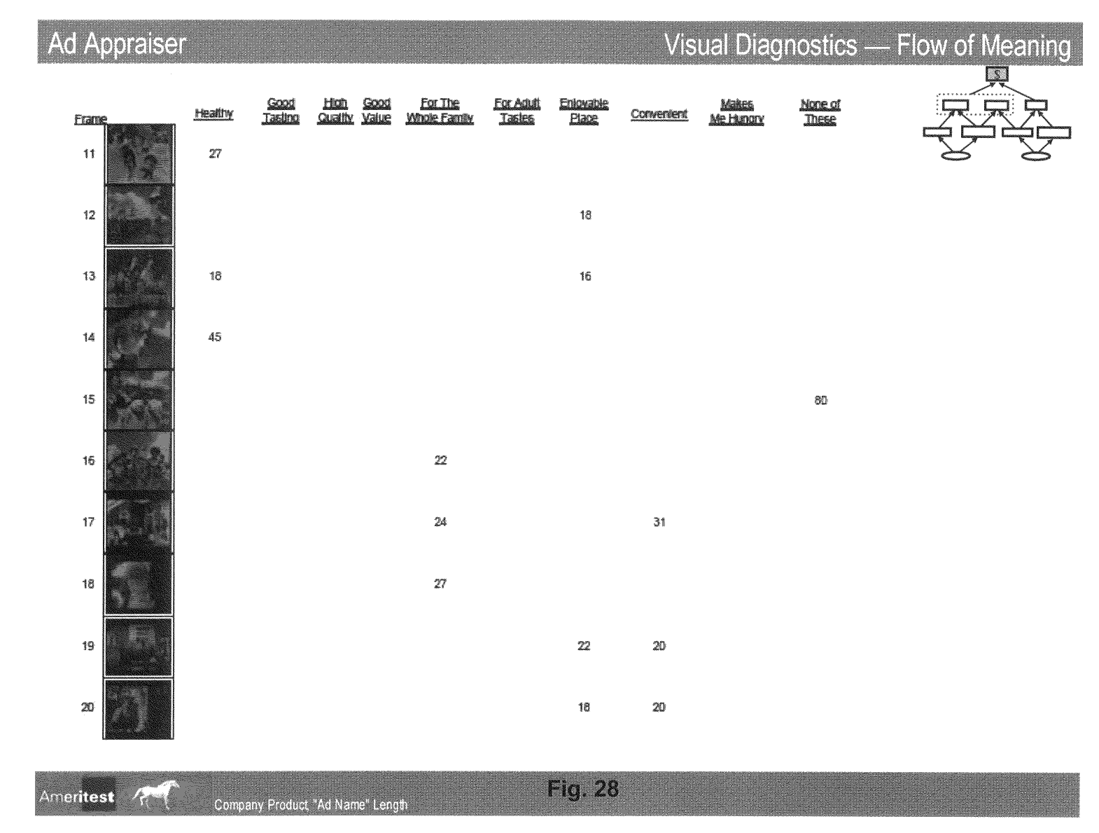

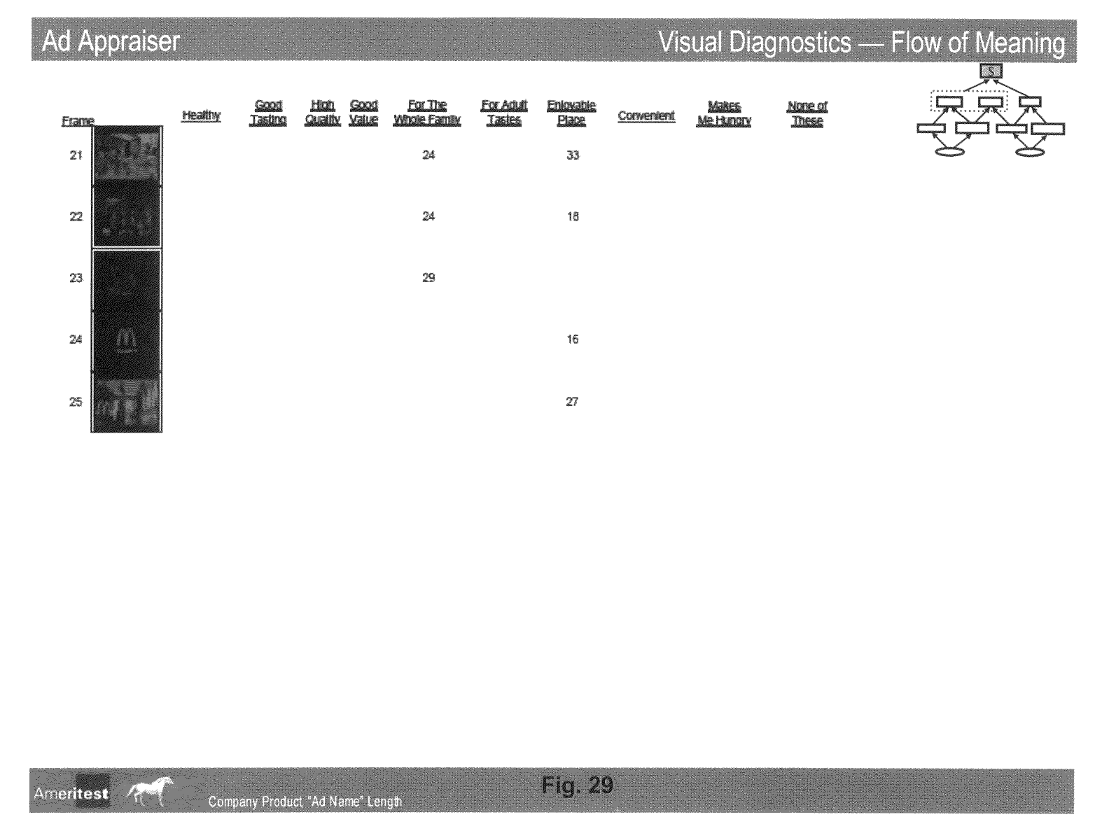

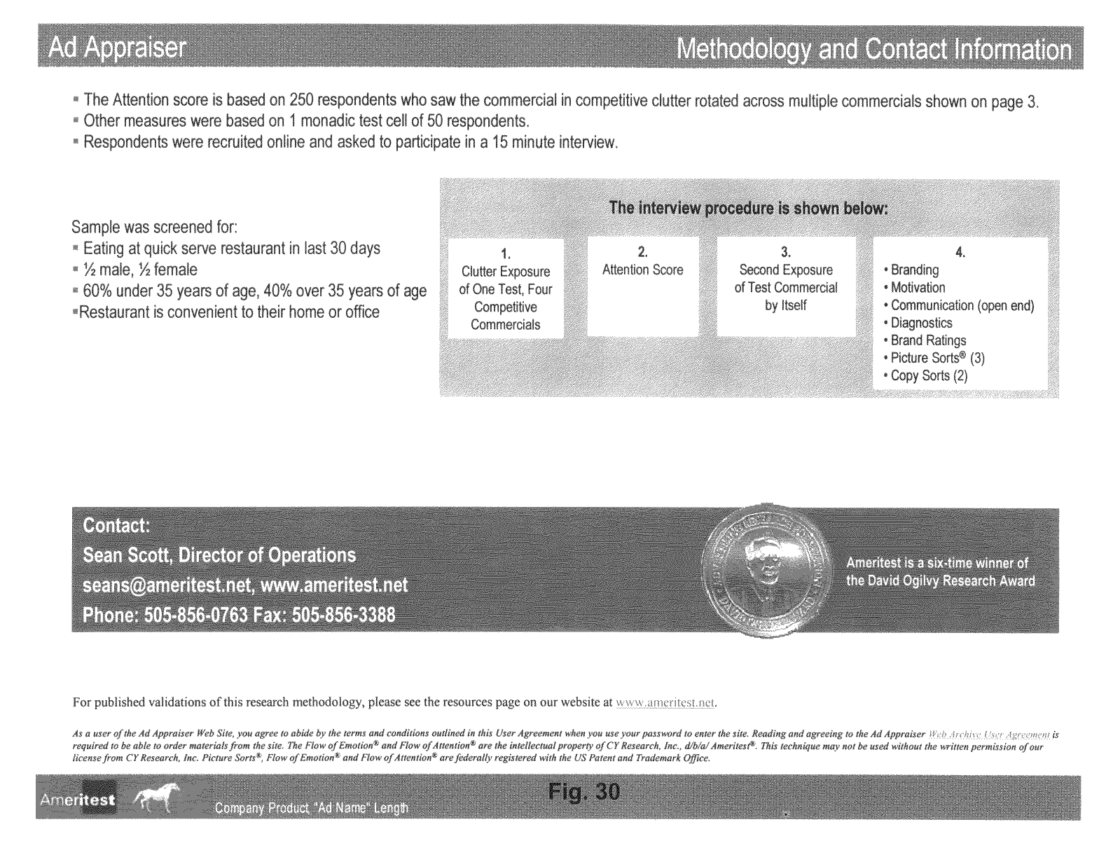

FIG. 4 is a screen shot of a detail (report) view concerning a particular advertisement. One can click on the image shown to actually view the advertisement and hear the associated audio portions. The advertisements' scores are shown, along with company and category averages (the latter being preferably set to 100 (i.e., the scores are preferably normalized)). More detailed printable diagnostic reports, including details concerning the Flow of Emotion®, Flow of Attention®, and Flow of Meaning™ metrics employed by the invention, can be purchased for each advertisement. An example of a report is shown in FIGS. 11-30, which includes, for example, analysis of the attention getting power of the ad, the strengths and weakness of the advertising execution that are correlated with attention getting power, the motivational power of the ad, and the strengths and weaknesses of the advertising execution that are correlated with motivational power The report also includes which brand values are being communicated by the ad the meaning of individual images in the ad that are cueing the overall ideas in the ad.

FIG. 5 is a screen shot of a detail view (image bank) concerning a particular advertisement broken down by a plurality of frames within the advertisement. One can view the changes in the “flow of meaning” with respect to brand values, as well as note changes in attention and positive/negative emotion (flow of emotion) scores through the advertisement. This can help advertisement managers to determine techniques that seem to be working/not working vis-à-vis attention or one or more brand values. The user can sort by the highest ranking image in a particular advertisement, or the user can view the highest ranking image for each advertisement.

FIG. 6 is a screen shot of a detail view of a particular frame of a particular advertisement, preferably selected by choosing Picture Sorts as shown in FIG. 5. Again one can view the scores associated with the particular frame. For each image the percentage of positive or negative Flow of Emotion and the percentage Flow of Meaning is shown. One can also sort the frames of an advertisement by a particular score and then view them one at a time via the standard arrow buttons below the image.

FIG. 7 is a screen shot providing to a new user descriptions of the types of information provided by the present invention. FIG. 8 is a screen shot detailing to a new user the types of information searches that can be conducted with the present invention.

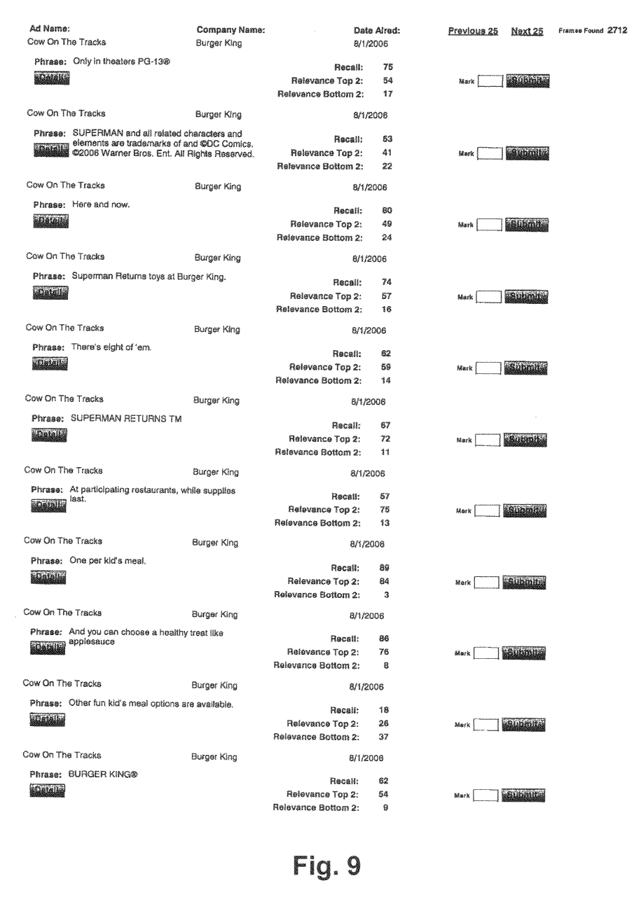

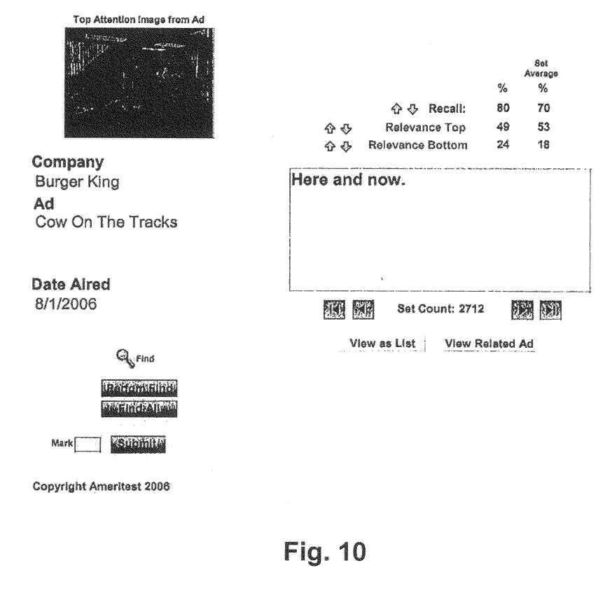

As shown in FIG. 9, each phrase in a particular advertisement may be evaluated based on recall and relevance, as perceived by the evaluation respondents. The testing results are preferably based on the highest-ranking image per ad per company, and reveal the most effective ad images among the companies evaluated, according to the comparative analysis taught above. Each specific phrase or copy for a particular advertisement (such as “Here and Now”) may also be evaluated and examined, as shown in FIG. 10. The customer is able to view both the copy and corresponding select images from every advertisement. Viewer's recall is measured by percentage alongside the set average. Measurements of relevance are also displayed.

As readily understood by one of ordinary skill in the art, the invention can easily be adjusted to deal with print advertisements, audio (e.g. radio) advertisements, or web advertisements by adjusting the functionality described above.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A method for analyzing and comparing advertisements, the method comprising the steps of:
obtaining a plurality of advertisements which are currently being displayed;
selecting portions of each advertisement;
automatically generating a survey comprising the portions of a particular advertisement and questions regarding the portions and the advertisement;
electronically sending the survey to a plurality of viewers;
automatically analyzing responses from the viewers;
correlating appropriate responses with each portion;
creating a database of scores for each advertisement and each portion;
ranking the advertisements via a plurality of first criteria;
ranking the portions according a plurality of second criteria; and
displaying the advertisements and portions and rankings thereof on a plurality of internet web pages.

2. The method of claim 1 wherein the portions are selected from the group consisting of video frames, portions of a print advertisement, and phrases.

3. The method of claim 1 wherein the analyzing step comprises generating one or more graphs selected from the group consisting of Flow of Attention, Flow of Meaning, and Flow of Emotion.

4. The method of claim 1 further comprising the step of providing one or more reasons used to derive each ranking.

5. The method of claim 1 wherein the method is completed in less than about two weeks from a release date of an advertisement.

6. The method of claim 5 wherein the method is completed in less than about forty-eight hours from the release date.

7. The method of claim 1 wherein the database is limited by one or more criteria selected from the group consisting of advertisement date, advertiser, sample definition, ranking criteria, and brand values.

8. The method of claim 1 wherein the advertisements are sortable according to any of the first criteria.

9. The method of claim 1 wherein the portions are sortable according to any of the second criteria.

10. The method of claim 1 wherein the criteria are customized for each industry area.

11. The method of claim 1 wherein the first criteria are the same as the second criteria.

12. The method of claim 1 wherein the displaying step comprises displaying criteria for more than one advertisement on a single web page.

13. The method of claim 1 wherein the displaying step comprises displaying criteria for more than one portion of a particular advertisement on a single web page.

14. The method of claim 1 wherein the displaying step comprises displaying criteria for one portion each of a plurality of advertisements on a single web page.

15. A method of creating an advertising campaign comprising analyzing advertisements using the method of claim 1.

16. The method of claim 15 further comprising the step of analyzing highly ranked portions of the advertisements.
